(19) United States
(12) Patent Application Publication
(10) Pub. No.: US 2008/0266549 A1
(43) Pub. Date: Oct. 30, 2008

(54) Chemical Constituent Analyzer

(75) Inventors: Steven A. Schiedemeyer, Ardin, WI (US); Mark J. Weber, Marshfield, WI (US)

Correspondence Address: LANE PATENTS LLC, 100 NORTH 72ND AVE., SUITE 107, WAUSAU, WI, 54401, US

(73) Assignee: ESE INC., Marshfield, WI (US)

(21) Appl. No.: 12/047,105

(22) Filed: Mar. 12, 2008

Related U.S. Application Data
(60) Provisional application No. 60/914,165, filed on Apr. 26, 2007.

(51) Int. Cl. G01N 21/00; G01N 21/01

(52) U.S. Cl. 356/73; 356/244

(57) ABSTRACT

The present invention relates to the use of Near-Infrared (NIR) spectroscopy to the application of the measurement of constituent concentrations of chemical based products typically having covalent bonding. Such constituent products may be fat, moisture, protein, and the like typically in liquid form or colloid suspensions. More specifically, the invention is directed toward an NIR analyzer with multiple detectors with no moving parts. The invention utilizes thermal control in conjunction with normalization algorithms to allow parallel processing of the measurements between a reference and at least one sample, which may provide more accurate results. In addition, this invention has the ability to use NIR in the third overtone and allows insitu processing, with no waste stream.

### REFERENCED APPLICATION(S)

The present application is a continuation-in-part of U.S. provisional patent application Ser. No. 60/914,165; filed Apr. 26, 2007, for ORGANIC CONSTITUENT ANALYZER, included herein by reference and for which benefit of the priority date is hereby claimed.

### FIELD OF THE INVENTION

The present invention relates to the use of Near-Infrared (NIR) spectroscopy to the application of the measurement of constituent concentrations of chemical and organic products using a single broad spectrum light source with a multiplicity of detectors, whereby measurements of a sample and reference are made substantially in parallel.

### BACKGROUND OF THE INVENTION

Spectrophotometery, also known as spectrometry, or relative spectrometry, has been used for decades to measure sample amounts of various constituents in samples. The principle behind spectrometry is that certain characteristic bonds in the constituent chemistries for example; hydrogen, nitrogen, and carbon bonds and the like, absorb and or scatter light of various wavelengths as they pass through the sample. There are several methodologies commonly used for spectrometry, such as reflectance, transmittance and absorbance.

Typically in the art, reflectance spectrometry is used due to the opaqueness of samples seen in the food processing industry. Most processors use the spectrum of the second overtone, which is above 1400 nm for which transmittance is poor. Transmittance spectroscopy can provide more accurate results at shorter wavelength transmittance in the range between 650 nm and 1400 nm, also known as the third overtone. The third overtone can be used in transmittance by using a broad spectrum light source. The challenge has been achieving the accuracy needed across the broad spectrum with such short wavelengths to allow sensitivity for concentration detection of the various constituents desired to be measured. Therefore, the need is felt to provide a methodology and apparatus that allows useful transmittance spectrometry in the third overtone.

One challenge with achieving this objective, is that the photon to electron conversion across a broad spectrum, can be an extremely delicate process which can be thrown off by even the smallest of error sources such as stray currents or temperature gradients in the electronics causing changes in threshold voltages or currents. Strict control of the temperatures of any of the multiplicity of optical benches, which are typically sensitive at every pixel wavelength, should be maintained, in order for the invention to function with the desired accuracy.

For this reason, prior art solutions send the light source through an optical switch which physically opens and closes shutters to send the single light source through a reference to an optical bench, then serially switches to activate a shutter which redirects the light through a sample and back to the same optical bench. The prior art solutions, using serial processing, are cumbersome and expensive and require the presence of moving parts, which can wear out and break down. An example of serial processing is found in U.S. Pat. No. 6,512,577 by Ozanich discloses the use of multiple spectrometers with a light source split between a reference and a sample, using a light collector, or as he calls it a “light doctor.” A serial processor as described by Ozanich required a dedicated spectrometer to “monitor the light source intensity and wavelength output directly, providing a light source reference signal that corrects for ambient light and lamp, detector, and electronics drift which are largely caused by temperature changes and lamp aging.” Without this dedicated spectrometer it would be very difficult to monitor relative drift between several benches.

Those skilled in the art of relative spectroscopy should recognize the advantage of parallel processing to measure samples faster, while still maintaining reading integrity as relative drift is reduced. Parallel readings also allows more consistent results in real time. Another key advantage is the elimination of moving parts from the light sampling path.

### SUMMARY OF THE INVENTION

The analyzer offers a way to control the accuracy of readings using multiple optical benches, removing temperature gradients to better correlate the electronics to enable parallel processing for spectral analysis. This apparatus and methodology can be applied to two or more optical benches, as needed by the application. Consistent temperature along each optical bench gives more consistent results, and can be accomplished by controlling the temperature inside a casing, within an acceptable temperature range, along with maintaining a tightly controlled environment of the optical bench, or benches. This can be done by maintaining a well controlled, yet higher temperature in the sensitive electronics, for example an optical bench or benches which may be approximately 10 to 20° F. higher than that inside the casing. A typical example would be to maintain a temperature of 95° F. inside the casing and a 115° F. temperature on the optical bench through a thermal management system, which can control and maintain the temperature of the optical benches.

Eliminating the optical switch, can allow both the sample and the reference to be read virtually in parallel, as opposed to serial processing, which requires optical switches. This improvement has been seen to reduce the overall processing time from thirty seconds using prior methods to approximately 5 seconds or better.

Greater penetration of the sample can be achieved by being able to read transmittance readings in the third overtone, facilitating the ability to do in situ readings, instead of pulling off samples or diverting a waste stream to measure the process flow.

It is therefore an object of the invention to enable parallel processing instead of sequential processing by having multiple optical benches, allowing more consistent results.

It is another object of the invention to measure and calculate constituent measurements in real-time.

It is another object of the invention to aid transmittance methodology in the third overtone, while still allowing other wavelengths to be used.

It is another object of the invention to use one light source, simultaneously between multiple receptors.

It is another object of the invention to allow insitu measurements, thus eliminating a waste stream.

It is another object of the invention to provide a means for measuring multiple constituents of a product with one module.

It is another object of the invention to provide the ability to calculate multiple constituent values concurrently.

It is another object of the invention to provide an apparatus which is portable.

It is another object of the invention to provide a large path length for measurement.

It is another object of the invention to eliminate moving parts from the NIR measurement systems.

It is another object of the invention to eliminate customized electronics that are difficult to manufacture and maintain.

It is another object of the invention to utilize a method to thermally control the optical bench of the spectrometers.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a schematic view of an organic constituent analyzer of the present invention;

FIGS. 2a and 2b are perspective views of embodiments of a splitter;

FIG. 3 is a schematic view of the optical cabling of the present invention;

FIG. 4 is a schematic view of the electronics for the thermal management system of the optical bench of one embodiment of the present invention;

FIG. 5a is a face on view of the thermal management system of one embodiment of the present invention;

FIG. 5b is a top down view of the heater element and spacer block;

FIG. 6 is a graph showing an example of a spectrum of a moisture content reading using an apparatus of the present invention;

FIG. 7 is a graph showing an example of multiple spectra showing a baseline reading, which comes through the sample path, and the reading for cream cheese using an apparatus of the present invention;

FIGS. 8a and 8b show a schematic representation of the heater control circuitry.

FIGS. 9a and 9b show side and top perspectives of a splitter.

FIGS. 10a and 10b show a side perspective of a product sample holder assembly.

### DETAILED DESCRIPTION OF THE DRAWINGS

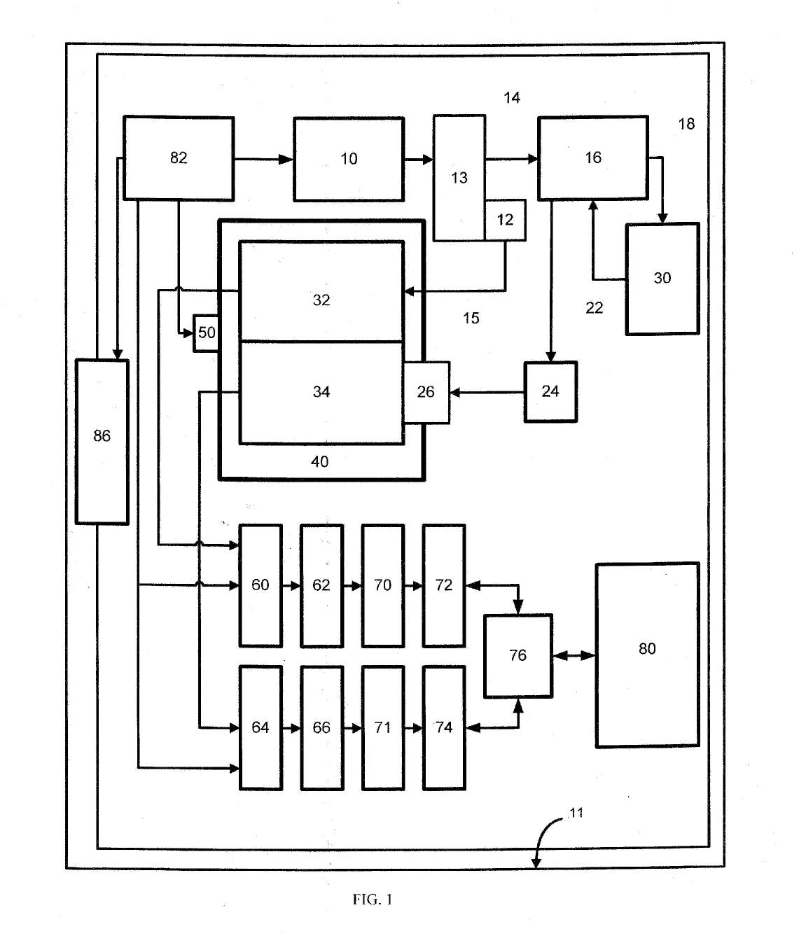

FIG. 1 depicts a schematic block diagram of the multiple spectrometer apparatus for measuring chemical constituent concentrations inside a casing 11. In a preferred embodiment, a power supply 82 powers a light source 10 typically in the range of 500 to 1200 nm. Other embodiments may include light at different wavelengths that would enable accurate transmittance using a broad spectrum, or from other sources, such as LED or arrangements of multiple LED's to form a broad spectrum. The light from the light source 10 may be directed through a splitter 13 that sends unfiltered light to a director junction 16 and the remaining light, as desired, through a filter 12. The tuning of light through the use of filters may be omitted, or used as determined by one skilled in the art. The splitter 13 regulates the unfiltered light into the interface coupling 14, which typically leads into a fiber-optic or other suitable cable, where it travels to the director junction 16. The director junction 16 serves the function of routing the light along a path to sample 18, through a product sample holder assembly 30, which holds a sample for reading, and further routes the light along a return path 22 back into the director junction 16. From the director junction 16 the light signal is carried through a splitter junction 24 to the optical bench input node 26 where it then interfaces with the sample optical bench 34. Simultaneously, the filtered light travels along a reference cable 15 which routes a signal to a reference optical bench 32 to give the corresponding real time baseline signal from which the sample signal is processed.

Both the reference bench optical system 32 and the sample bench optical system 34 are coupled with a thermal management system 40, to provide a photon to electron conversion, turning the spectral light signal into electrical signals for further processing. The purpose of the thermal management system 40 is to maintain a substantially identical temperature along the multiplicity of optical benches. The thermal management system may further be comprised of a housing of insulation to regulate stray thermal losses and further decouple the thermal management system from the ambient surroundings.

After the optical bench systems 32 and 34 convert the signal from optical to electrical signals, the electrical signals are routed to their respective reference spectrometer 60 and 64, for processing. Typically, this may involve using the step of sending the respective analog signals through analog to digital (A/D) converters 62 and 66 where the analog signals are then converted into their respective digital signals. The communication interfaces 70 or 71, transform the signals into a reference output 72 or a sample output 74, respectively. The output signals are then merged into a data hub, which can be a networking hub or USB hub or similar data device, where they are ready for interfacing with a chemometrics processor 80; which can be a microcontroller, microprocessor, ASIC, host computer or the like having sufficient capability to form a meaningful analysis of the data and relay it to a user interface generally for decision making purposes.

In other embodiments, the orientation and components described in the schematic can be designed to accommodate multiple sampling, whereby several samples can be measured in parallel with each other, and a reference or multiplicity of references.

The enclosure cooling unit 86 serves to cool the electronics inside the casing 11. In one preferred embodiment, the temperature inside the casing 11 is maintained at approximately 80° to 95° F. The heater element 50 for the thermal management system 40 is maintained at a substantially fixed temperature of 115° F.±0.5° F. This is possible in part because of the relatively lower temperature in the casing 11 maintained by the enclosure cooling unit 86. Other embodiments may include alternative temperature ranges consistent with the purpose of preventing thermal runaway inside the thermal management system 40, while still providing external heating to the circuit junctions such that the temperature differential along the multiplicity of optical benches is minimized, even though the various circuits may be running at different duty cycles. Such tight control of the circuit junction temperature controls leakage and stray currents often associated with reversed biased p-n junction leakage, gate leakage and the like.

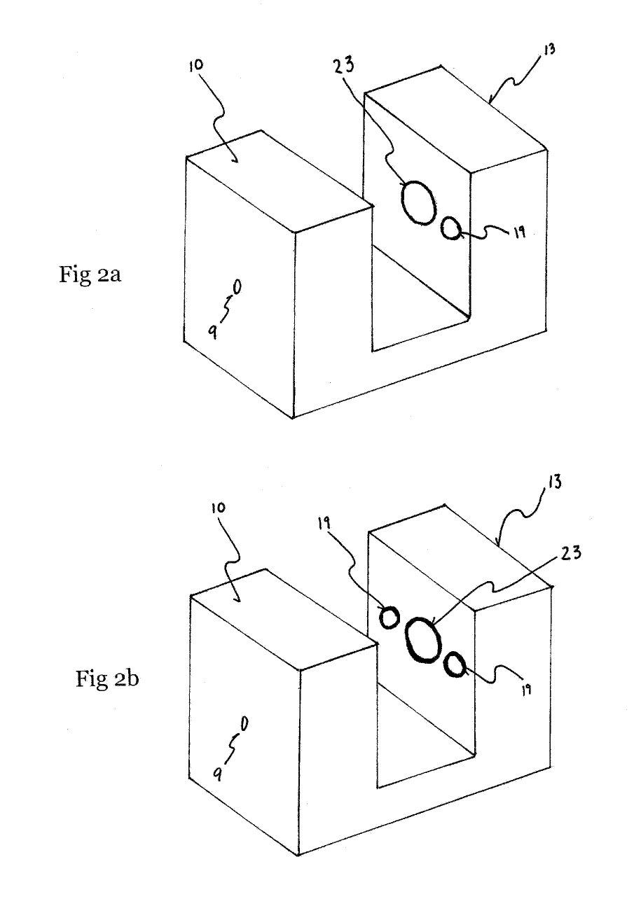

FIG. 2a is a perspective view of the interior of an embodiment of a splitter 13. The light source 10 is directed toward the inside facing of the splitter 13. In a preferred embodiment, the light is filtered through a filter 12 at the filter pathway 19, where predetermined wavelengths are filtered before the light continues along a reference cable 15 to the reference optical bench 32. Light from the light source 10 enters the cable interface pathway 23 into the interface coupling 14, which typically leads into a fiber-optic or other suitable cable, where it travels toward the sample through the director junction 16, as herein described. In the preferred embodiment, the gap between the light source 10 and the inside facing of the splitter 13 is adjusted to align the focus of the light source 10 into the aperture of the cable interface pathway 23 to increase the intensity of the light sent toward the sample. Other embodiments to increase measurement accuracy may include adjusting the gap in the splitter between the source 10 and the aperture, adjusting the cable used along the pathway 23, adjusting the path length to sample and adjusting the focus of the source 10.

FIG. 2b is a perspective view of the interior of a preferred embodiment of a splitter 13, where a light source is split among two filter pathways 19 and a cable interface pathway 23. Other embodiments can be anticipated where at least one light source is split among a multiplicity of filter pathways or cable interface pathways 23.

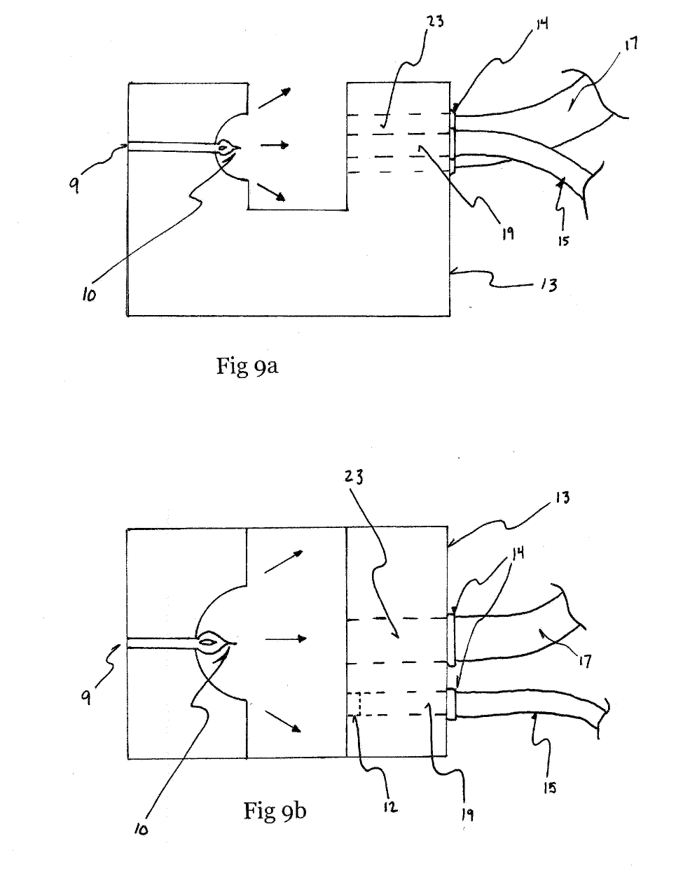

FIG. 9a is a side perspective of the preferred embodiment of a splitter 13, where a light source 10 is directed toward a filter pathway 19 and a cable interface pathway 23, as herein described. FIG. 9b is a top view perspective of a splitter 13, where a light source 10 is directed toward a filter pathway 19 and a cable interface pathway 23, as herein described. The light travels through a filter 12 before continuing along the filter pathway 19.

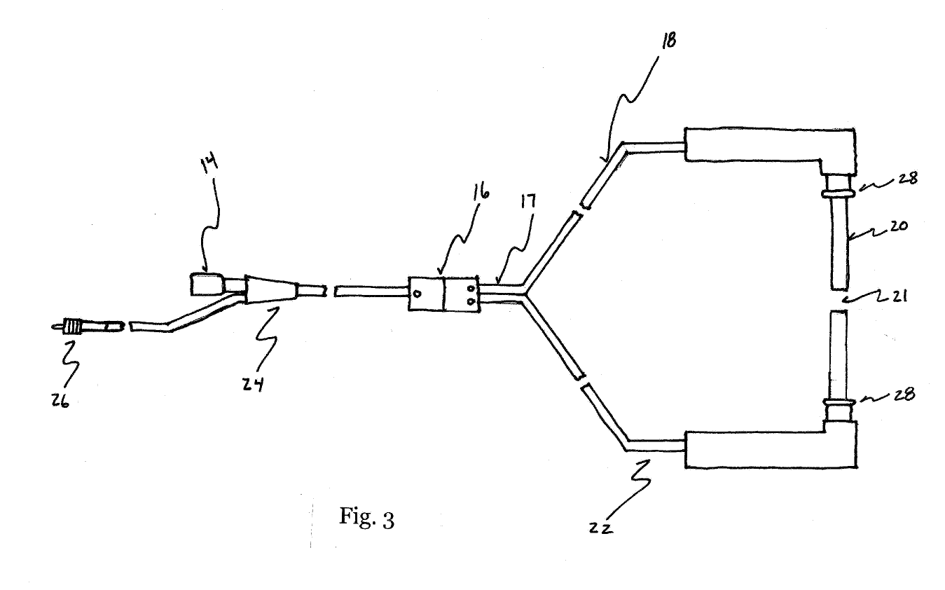

FIG. 3 is a schematic view, showing elements of the optical cabling used in the preferred embodiment. The interface coupling 14, which is typically a fiber-optic cable, comprised of borosilicate fibers with preferably a maximum of 5% broken fiber and of sufficiently large diameter to be immune to light deflection due to the cable motion and vibrations found in operation, and is routed through a director junction 16 which serves to direct the cable into a cable bundle 17 along a path to sample 18 into the measurement rod 20 which can be inserted into a product sample holder assembly 30 which is typically housed in a receiving collar, a sample holder, or other like assembly, where a sample can be found. The measurement gap 21 selected can be a function of the opacity of the chosen sample. One skilled in the art would be able to tune the gap for characteristics of the sample of interest.

Once the light is transmitted from one measuring rod 20 to an opposite measuring rod 20 through a measurement gap 21 which can be found in a sample holder assembly 30, the light proceeds along the return path 22 where it is eventually split through the splitter junction 24 and to the optical bench input node 26. Alternative embodiments of the optical cabling are anticipated where multiple samples are measured, or alternate cabling paths are utilized to accomplish the routing as herein described.

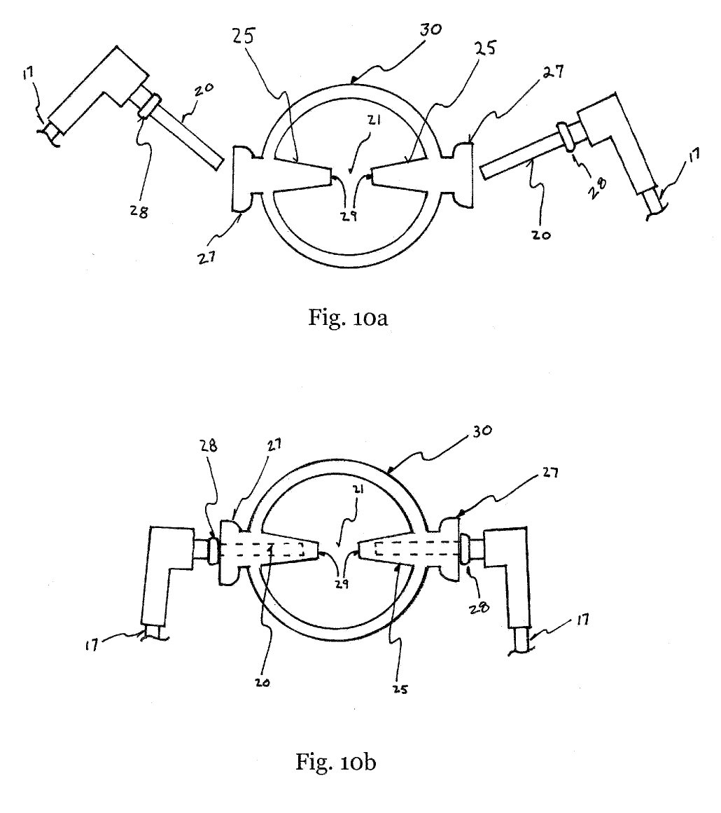

FIGS. 10a and 10b show a side perspective of a product sample holder assembly 30, as an illustration of how it is used for in situ measurement of a sample. The perimeter of the product sample holder assembly 30 is generally formed by a section of pipe along which a product, from which the sample is taken, is formed. A sample in this method and accompanying apparatus may be taken from a wide variety of chemicals, many times organic, and more often a food product, which can include dairy, beverages or byproducts. A preferred embodiment of the assembly 30 is made of 304 stainless steel or similar material suitable for direct food contact. Measurement rods 20 are attached to the optical cables that are connected to the analyzer and placed inside the assembly 30 by insertion into the cannular alignment structures 25 as shown in FIG. 10b. The mounting collar 27 helps align and govern the penetration of the rods 20 into the assembly 30. A mounting rod seal 28, which can be an o-ring or similar device, is provided to further seat and seal the sample chamber and keep light from leaking into the assembly 30. The exposed ends of the cannular alignment structures 25 are fitted with a sealed lens formed from Teflon® or a suitable substance, usually a hardened plastic, with good durability and light transferring ability such that it forms a hermetic lens 29 that acts as a hermetic seal to protect the spectral sample, which may be a food substance, from contaminants found in the outside environment yet still allows sample readings to be made in the interior of the assembly 30. The hermetic lens 29 is substantially permanently affixed to the assembly 30, while the rods 20 may be removably secured into the assembly 30 by a variety of mechanisms such as a latch, tie, strap, compression fitting or similar securing means. This allows in situ sample readings without breaking the flow of product from the product stream.

Other embodiments can replace the gap 21 with a product holder, trap or similar device to capture the sample for in situ measurement.

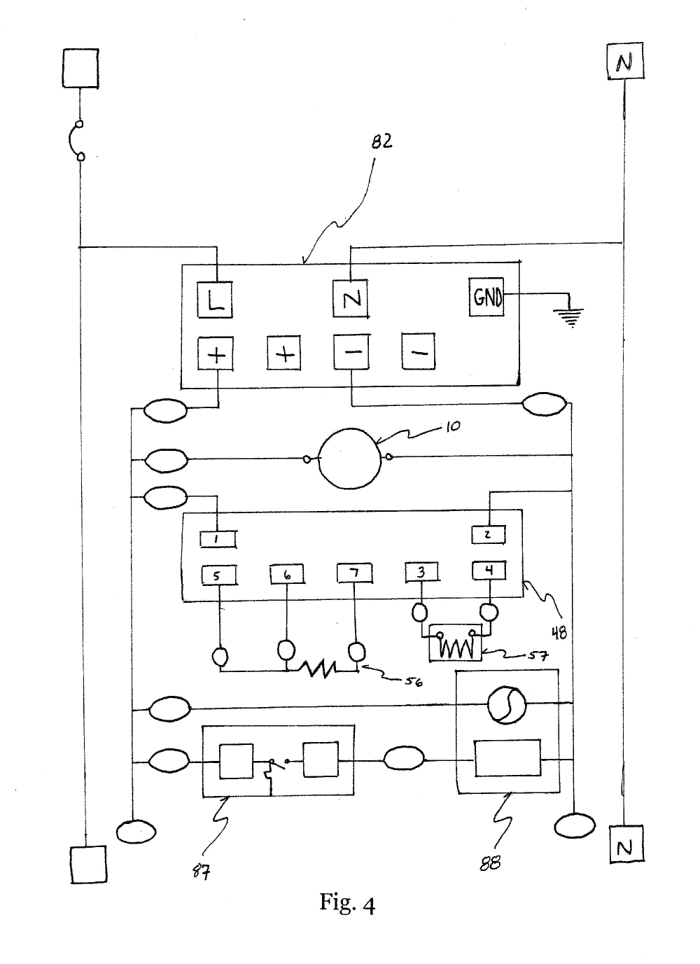

FIG. 4 shows an electrical schematic of one embodiment of how the temperature of the casing 11 and thermal management system 40 may be regulated. The power supply 82 provides voltage for the light source 10, the temperature controller 48 of the thermal management system 40, the enclosure cooling unit 86 and its related thermostat 87 and thermal electric cooler 88. The circuitry allows the independent regulation of the temperature inside the casing 11 by regulating the thermostat of the enclosure cooling unit 86, relative to the temperature of the thermal management system 40.

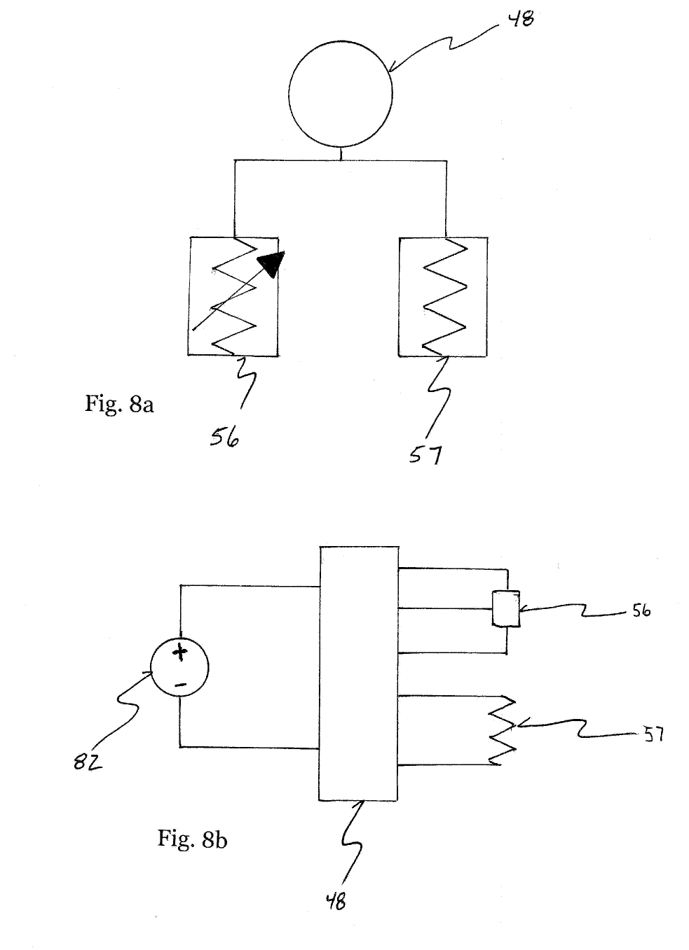

FIG. 8a is a symbolic representation of the heater control circuitry related to the temperature controller 48. FIG. 8b is an electrical representation of the devices used in the heater control circuitry related to the temperature controller 48.

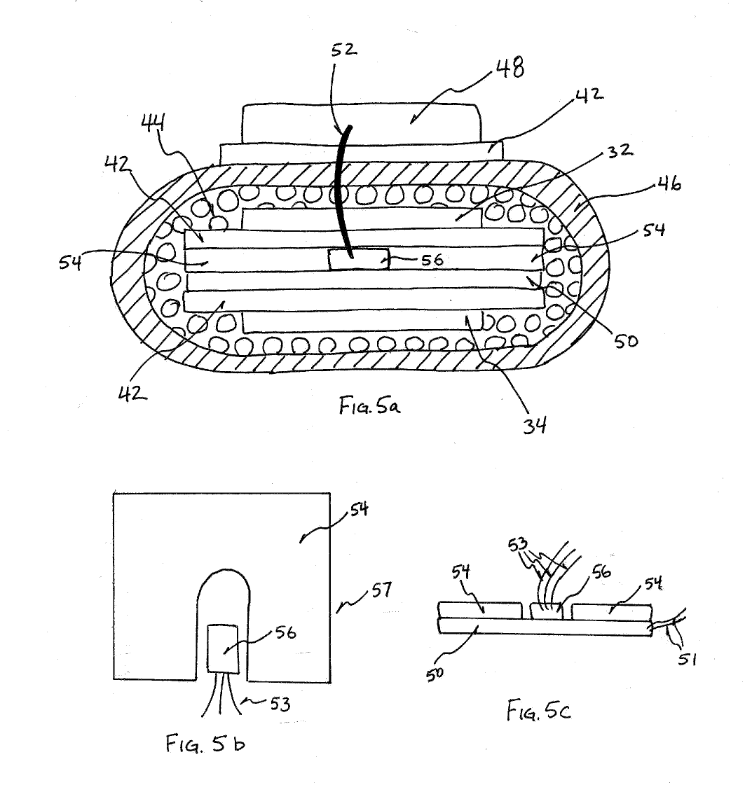

In FIG. 5a an embodiment of a thermal management system 40 includes a temperature controller 48 which is coupled with a heater element 50. The purpose of the heater element 50 is to provide enough local heating that when added to the heat generated by the reference 32 and sample 34 optical benches maintains the constant temperature of approximately 115° F., which can be sufficient to overcome cooling. A spacer block 54, preferably made of aluminum, copper, or other like heat conducting material provides a backplane for optical benches 32 and 34, and is also coupled with a heater element 50 which heats the optical benches 32 and 34 through the spacer block 54 and board mounting bracket 42. Insulation 44, such as foil covered bubble wrap, is wrapped or packed around the heater board subassembly. The entire assembly is then encased in an encasement 46, which can be a shrink wrap, in order to hold the assembly together. The board mounting brackets 42 are made of a suitable material to promote even distribution of heat between the reference optical bench(s) 32 and the sample optical bench(s) 34 as regulated by the temperature controller 48 largely confined within the encasement 46. One skilled in the art will appreciate that there are several means to accomplish establishing a common reference temperature along the optical benches 32 and 34 by using a heater 57, typically comprised of elements such as; a resistance temperature device 56, a temperature controller 48, with a heater element 50 to maintain a uniform distribution of temperature, and a spacer block 54, which do not depart from the spirit of this disclosure. Such as, but not limited to, separating or coupling smaller numbers of sample and reference bench(s) into compatible groupings.

In the preferred embodiment, the temperature of the thermal management system 40 can be maintained higher than the relative ambient temperature of the casing 11, causing heat to leave the thermal management system 40 into the casing 11, where it can be blown out of the casing 11 by the enclosure cooling unit 86. The insulation 44 of the controller keeps the temperature inside substantially constant. Detector sensitivity is controlled by minimizing a change of temperature along the optical benches 32 and 34, giving more consistent and accurate results. Driving the heat outward from the system 40 enhances the ability to control and balance the temperature of the benches 32 and 34.

The conductive properties of the spacer block 54 can be enhanced by the use of a thermal paste or gel to allow a good transfer of thermal energy substantially promoting temperature stability and uniformity among the benches 32 and 34. This assures that the junction temperature of any circuit on one optical bench is substantially the same as the junction temperature of another circuit within the same optical bench, resulting in uniform detector element sensitivity.

FIG. 5b shows the relative layout of a typical heater 57 comprised of a means for heating comprising a resistance temperature device 56, inserted into a cavity in the spacer block 54 is shown. A heater element 50, as shown in FIG. 5c, may be coupled with the resistance thermal device 56 and spacer block 54 in order to enhance the thermal dispersion. The resistance temperature device 56 and heater element may communicate with a temperature controller 48 through heater wires 51 or resistance thermal device wires 53. Those skilled in the art will appreciate that there are many ways this thermal management system 40 can be embodied without departing from the spirit of this invention.

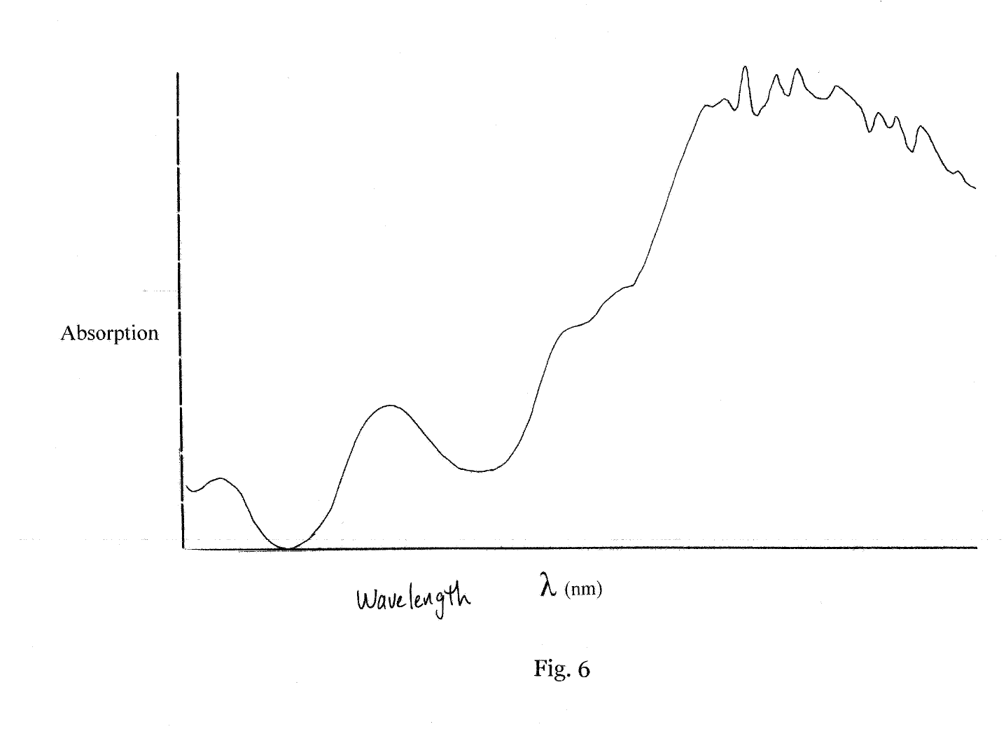

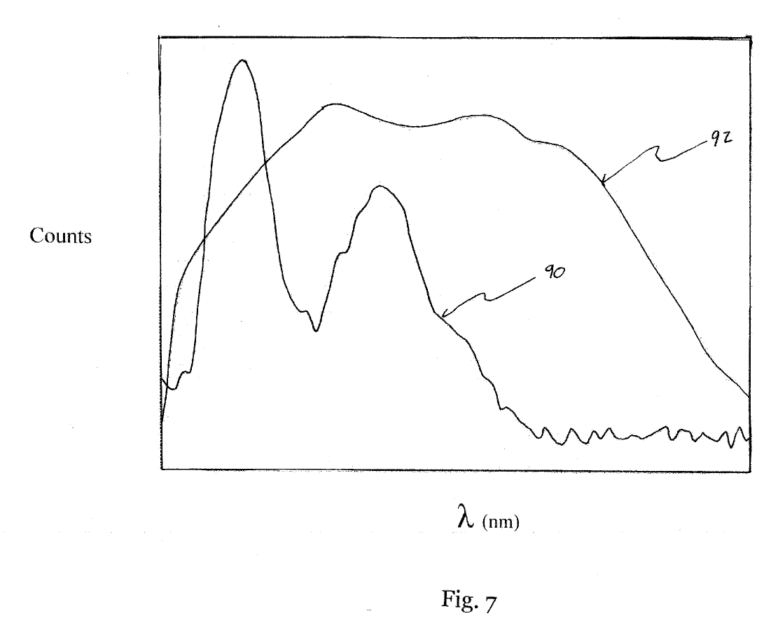

FIGS. 6 and 7 show various intermediate outputs of the present invention such that they can be appreciated by those skilled in the art. FIG. 6 shows a moisture absorbance spectra and FIG. 7 shows count results per wavelength to compare a sample reading 90 and reference reading 92. Such readings may form the input for a chemometrics processor 80.

FIGS. 8a and 8b show a schematic representation of the heater control circuitry. The resistance temperature device 56 and heater 57 are regulated by the temperature controller 48, which is powered by the power supply 82.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

For example the range of wavelength in the measurement may vary from application to application, depending upon the constituent being measured as well as insitu verses batch verses sample application.

Having thus described the invention, what is desired to be protected by Letters Patent is presented in the subsequent appended claims.

What is claimed is:

1. An analyzer to measure the characteristics of a chemical composition, comprising:
i) a means for radiating a controlled beam;
ii) a means for forming a plurality of split beams, derived from said controlled beam, and directing said split beams through at least one sample of said chemical composition and at least one reference;
iii) a plurality of detecting means for measuring the split beam from at least one of said sample or said reference,
iv) each said detecting means being coordinated with a separate said split beam for measuring the beam strength at predetermined wavelengths of said split beam, whereby each measurement is converted into an electrical signal;
v) a processing means for taking each said electrical signal and making a determination from said electrical signal;
whereby said determination is made by said processing means substantially simultaneously.

2. The analyzer of claim 1, wherein said sample further comprises at least one of carbon and hydrogen chemical bonds.

3. The analyzer of claim 2, wherein said sample is a food product.

4. The analyzer of claim 1, wherein said analyzer is enclosed in a casing having a controlled temperature.

5. The analyzer of claim 4, wherein the controlled beam comprises a light source having a broad electromagnetic spectrum.

6. The analyzer of claim 5, wherein the controlled beam comprises a light source having wavelengths between approximately 500 nanometers and 1200 nanometers.

7. The analyzer according to claim 5, wherein said analyzer uses transmittance spectroscopy.

8. The analyzer according to claim 7, wherein said transmittance spectroscopy utilizes a third overtone.

9. The analyzer of claim 4, wherein the path for at least one of the split beams further comprises a filter for regulating the controlled beam in said path.

10. The analyzer of claim 9, wherein said detecting means for measuring the illumination from at least one of the sample or the reference, further comprises at least one of a reference optical bench and a sample optical bench.

11. The analyzer of claim 10, where said filter separates out predetermined wavelengths from said controlled beam.

12. The analyzer of claim 1, wherein said detecting means for measuring each split beam provide a photon to electron conversion.

13. The analyzer of claim 12, wherein said optical benches are coupled with a thermal management system.

14. The analyzer of claim 13, wherein said thermal management system further comprises a temperature controller for maintaining a substantially controlled temperature between said optical benches.

15. The analyzer of claim 14, wherein the temperature inside said casing is maintained at a lower temperature that the temperature of said management system.

16. The analyzer of claim 12, wherein said processing means for converting said electrical signal into a processing signal further comprises converting the electrical signal from a reference optical bench into a digital reference output, using a reference spectrometer, a reference analog to digital converter and a reference communication interface.

17. The analyzer of claim 16, wherein said processing means for converting said electrical signal into a processing signal, further comprises converting the electrical signal from a sample optical bench into a digital signal output, using a sample spectrometer, a sample analog to digital converter and a sample communication interface.

18. The analyzer of claim 17, wherein said data is processed by a chemometrics processor.

19. The analyzer of claim 18, wherein said chemometrics processor comprises a computer program executed by a microcontroller, microprocessor, ASIC, host computer or the like.

20. The analyzer of claim 18, wherein said digital reference output and said digital sample output are processed using a normalization algorithm, substantially in parallel.

21. The analyzer of claim 20, wherein said sample is analyzed in situ.

22. A method for utilizing spectroscopy comprising:
i) providing a light source having a broad electromagnetic spectrum;
ii) splitting said light source into a plurality of light signals directed through either a sample or a reference and to a plurality of optical benches, each said optical bench for making a measurement;
iii) transforming each said measurement from said optical benches into a format compatible with a processor;
whereby the analysis from said optical benches are made substantially at the same time.

23. The method of claim 22, wherein said light source contains wavelengths in the range of 650 to 1150 nm in the near infrared spectrum.

24. The method according to claim 23, wherein said thermal management system maintaining a substantially similar temperature between said optical benches.

25. A product sample holder assembly for measuring a sample in situ, comprising:
i) a pair of cannular alignment structures, each having an insertion end and a sealed interface and having a cavity large enough to accommodate a measuring rod or similar measurement device, whereby said measuring rod houses optical cables;
ii) each said sealed interface providing a hermetic seal between said sealed interface and each said cavity;
iii) each said insertion end providing a mounting collar to govern the alignment of said measuring rod;
iv) each said cavity being of a predetermined size to accommodate said measuring rod and sealing means for preventing said sample from entering said cavity;
whereby each said cannular alignment structures is connected in such a way that each said sealed interface faces one another at a predetermined width to form a measuring gap and each said cannular alignment structure lies substantially along the same axis.
